(19) United States
(12) Patent Application Publication
(10) Pub. No.: US 2004/0173083 A1
(43) Pub. Date: Sep. 9, 2004

(54) Music data producing system, server apparatus and music data producing method

(76) Inventors: Hidefumi Konishi, Kyoto (JP); Seiji Kurokawa, Kyoto (JP); Akihiro Aoi, Shiga (JP); Masuzo Yanagida, Kyoto (JP); Masanobu Miura, Shiga (JP)

Correspondence Address: DICKSTEIN SHAPIRO MORIN & OSHINSKY LLP, 2101 L STREET NW, WASHINGTON, DC, 20037-1526, US

(21) Appl. No.: 10/760,382

(22) Filed: Jan. 21, 2004

(30) Foreign Application Priority Data
Jan. 22, 2003 (JP) 2003-014098

(51) Int. Cl. G10H 7/00

(52) U.S. Cl. 84/612

(57) ABSTRACT

Music data is easily and positively produced from a melody the user imagined to himself/herself, without the need of musical expertise. Accepted are an input of a melody voice the user is singing to himself/herself and a key depression corresponding to a rhythm of the melody voice to be inputted. Depending upon a timing of the accepted key depression, voice pitch and note value are extracted from the melody voice. The produced music data is format-changed into a file for outputting at a terminal unit, and then sent toward the terminal unit.

### FIELD OF THE INVENTION

This invention relates to systems for producing incoming indicator melodies on cellular telephones for example, and more particularly to a system adapted for easily and positively producing a self-composed melody by the use of a terminal unit.

### BACKGROUND OF THE INVENTION

The recent cellular telephone is added with the function allowing for the user to set an incoming indicator melody to his or her taste. The incoming indicator melodysetting methods i include a method of selecting an incoming indicator melody previously stored in the terminal unit and a method of selecting and downloading a desired tune from among a plurality of tunes previously entered at the center, into an incoming indicator melody. Also, there is a method in which the user inputs a pitch, a voice length and the like by himself/herself into a setting as his/her own private incoming indicator melody.

In the meantime, such a private incoming indicator melody usually is set in the following manner. First, in the case to produce an incoming indicator melody, a melody-setting screen is displayed on the terminal-unit display screen, to input a voice tempo, volume and quality as the basic information for producing a tune. Then, in order to input data of a melody and the like, musical notes are selected one by one into plotting in position on a staff notation. This operation is repeated until all the data is completely input. Completing these operations, listening is done finally. After proper modification, entering is made as an incoming indicator melody.

However, in producing a private incoming indicator melody by such a technique, there is a need of musical expertise in a certain degree. Due to this, for the user not possessing musical expertise, there encounters an extreme difficulty in inputting his/her imagined melody directly onto the staff notation. In addition, it takes a plenty of time to input a pitch and musical note by the use of a terminal unit, such as a cellular telephone, not suited for inputting musical information.

In order to solve the problem, there are a variety of proposals of apparatuses and systems adapted for inputting melodies without the need to operate keys. For example, JP-A-11-220518, etc. disclose that the melody the user sings to himself/herself is speech-recognized and converted into digital data thereby being set into an incoming indicator melody. Besides those of documents, there is a system in real existence for converting the melody the user sings to himself/herself into music data by the use of a speech recognition art thereby making it possible to reproduce and use the melody. The system like this basically utilizes an input device directly connected to a computer, in order to determine a pitch, a note value and the like depending upon a melody voice the user has inputted by using the device.

However, the apparatus or system using such a speech recognition art has a strong tendency toward the ambiguous determination of a length for a pitch upon inputting a melody voice having a smoothly varying pitch or continuing equal pitches or upon a presence of rest. This makes complicate the process for modifying the recognized music data.

Therefore, it is an object of the present invention to provide a system which can easily and positively produce music data from a melody the user imagined to himself/herself without the need of musical expertise.

### BRIEF SUMMARY OF THE INVENTION

In order to solve the foregoing problem, the present invention accepts an input of melody voice and a depression of key corresponding to a rhythm of the melody voice to be inputted. Using the information about the key depression timing accepted, voice pitch information and voice length information are extracted from the melody voice. Due to this, music data can be produced and outputted for listening.

In this manner, by using the timing information inputted by the user, even where to input a melody voice smoothly changing or continuing in equal pitch or entering a rest, its voice pitch and note value can be correctly determined. Also, modification to music data can be reduced in improving recognition rate.

Meanwhile, when producing the music data, melody data is produced on the basis of the melody voice inputted by the user. Furthermore, on the basis of the melody data, accompaniment data such as chords is provided to thereby producing music data.

With this configuration, the higher level of music data processed with chording can be provided without being limited to merely producing the same melody as the melody voice inputted by the user.

Furthermore, sound input, key depression and music data output are carried out at the terminal unit end while music-data producing process is executed at the server end.

With this configuration, by using a well-functioning computer at the server end, an accurate and uniform producing process is possible on music data without relying upon terminal unit function.

Meanwhile, when sending the music data produced at the server end to the terminal unit end, the data is converted into a file form for outputting at the terminal unit and sent to the terminal unit.

This configuration eliminates the necessity of file conversion at the terminal unit end. Particularly, where the terminal unit is a small-sized terminal such as a cellular telephone, it is possible to suppress battery power consumption due to file conversion.

### BRIEF DESCRIPTION OF THE DRAWINGS

The foregoing and other advantages and features of the invention will become more apparent from the detailed description of exemplary embodiments provided below with reference to the accompanying drawings in which:

FIG. 1 is a schematic diagram of a music data producing system according to an exemplary embodiment of the invention;

FIG. 2 is a system block diagram of the system shown in FIG. 1;

FIG. 3 is a flowchart of the system shown in FIG. 1;

FIG. 4 is a display screen example of a terminal unit of the system shown in FIG. 1.

### DETAILED DESCRIPTION OF THE INVENTION

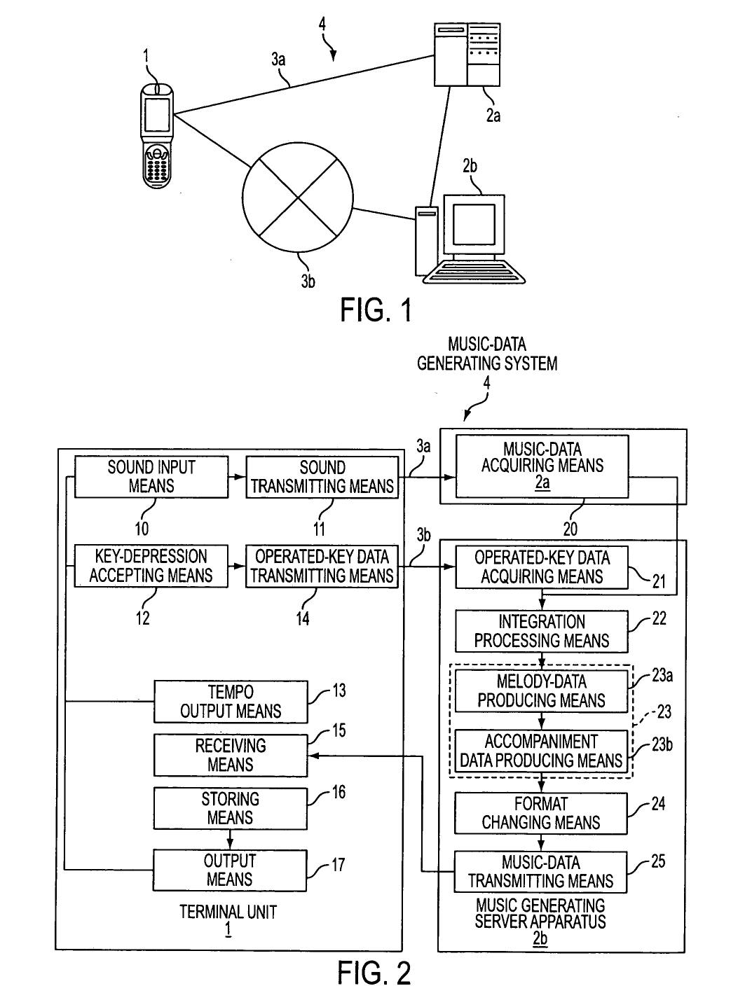

Referring now to FIG. 1, a music data producing system 4 in accordance with an exemplary embodiment of the present invention is shown. The present embodiment is configured with a cellular telephone as a terminal unit 1, a sound data acquiring apparatus 2a and a music producing server apparatus 2b. Note that the terminal unit 1 is explained with reference to a cellular telephone in this embodiment but is not limited to this, i.e. it can use a personal computer, a stationary-type telephone, a FAX, an AV set besides a portable terminal such as a PHS and PDA.

The music data producing system 4 is configured with a terminal unit 1, a sound data acquiring apparatus 2a, a music producing server apparatus 2b, and a telephone line 3a and data communication line 3b connecting between those. The terminal unit 1 accepts an input of melody voice and, concurrently, a key depression corresponding to a rhythm of the melody. These pieces of information are sent to the music producing server 2b through the music data acquiring apparatus 2a. At the end of music producing server apparatus 2b, a melody is produced and chording is made corresponding to the melody basically depending upon key-depression information. This data is sent toward the terminal unit 1 so that it can be used as an incoming indicator melody. The music data producing system 4 of this embodiment is now detailed on the constituent elements thereof.

Referring now to FIG. 2, the terminal unit 1 has at least sound input means 10, sound sending means 11, key-depression accepting means 12, tempo output means 13, operated-key data transmitting means 14, receiving means 15, storing means 16, output means 16 and so on. Besides these, a variety of means are provided to realize the function of a cellular telephone.

The sound input means 10 is configured by such a microphone as is usually arranged on the cellular telephone, to input as analog information a melody voice the user has sung to himself/herself. For the melody voice, a voice input is accepted after an input start is instructed by key operation according to an operation guide. The input acceptance is ended when an input end is instructed by key operation also according to the operation guide. The accepted melody voice is directly outputted to the sound sending means 11, or is stored in a memory of the terminal unit 1 and thereafter outputted to the sound transmitting means 11.

The sound transmitting means 11 is for sending, as analog information, the melody voice inputted by the sound input means 10 toward the music data acquiring means 2a. The sending is through the telephone line 3a as cellular-phone communication means to the side of server apparatus 2b.

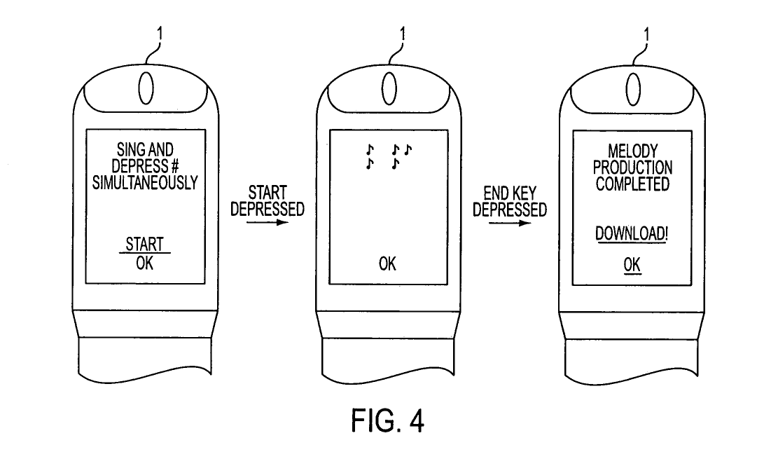

The key-depression accepting means 12 is for accepting a key depression timed to the rhythm of a melody voice to be inputted onto the sound input means 10. A key depression can be accepted in a manner as if using a percussion instrument. The key-depression accepting means 12 is configured by a key button, such as a ten key, as usually arranged on the cellular telephone, means for detecting a timing the key is depressed, and so on. Detecting a depression, the key-depression accepting means 12 measures a depression time and a time length between depressions of timing. Specifically, measured by a clock is a time period of from the time the key is depressed to the time the key is released, for example. The voice length is indicated on the display as shown in FIG. 4 and outputted to the operated-key data transmitting means 14, as shown in FIG. 2. Meanwhile, as for accepting the key depression, any of a plurality of keys may be accepted besides accepting a depression of a single key. Particularly, where to accept a plurality of keys, it is effective for the case to input a quick rhythm of melody.

Referring again to FIG. 2, the tempo output means 13 is for outputting a tempo for assisting a key depression, i.e. to periodically output a metronome voice timed to a predetermined tempo. As for outputting a tempo, outputting is commenced when depressing a start key for functioning the sound input means 10, and the outputting is terminated when depressing a key for ending the voice input.

The operated-key data transmitting means 14 sends the operated-key data concerning the key depression timing accepted corresponding to a rhythm, to the music producing server apparatus 2b through the data communication line 3b. In accompaniment therewith, read and sent from the storing means 16 are ID information about a telephone number of the terminal unit 1, e-mail address, etc., model information about terminal unit 1 and the like, as information for receiving music data from the music producing server 2b.

The receiving means 15 receives the music data sent from the music producing server apparatus 2b and delivers it to the storing means 16.

The storing means 16 is for storing the information needed to operate the terminal unit 1. Besides an operation executing program for functioning the cellular telephone, it stores ID information about a telephone number of one's own terminal unit and an e-mail address, and the music data received from the music producing server 2b, and so on.

The output means 17 is for outputting sound information, character information and the like. This is configured by a speaker or display.

Meanwhile, the sound data acquiring apparatus 2a acquires, the analog voice data sent from the terminal unit 1 through the telephone line 3a by sound data acquiring means 20, and outputs these pieces of information together with the ID information of the terminal unit 1 to the music producing server apparatus 2b.

Meanwhile, the music producing server apparatus 2b is configured with operated-key data acquiring means 21, integration processing means 22, music-data producing means 23, format changing means 24 and music-data transmitting means 25 and so on. Note that the music producing server apparatus 2b in this embodiment serves for various functions of acquiring music data and operated-key data and processing for producing music data. Where these functions are effected by a plurality of computers being coupled besides a single computer, such a system serves as a music producing server apparatus.

The operated-key data acquiring means 21 acquires the operated-key data of a depression timing corresponding to a rhythm sent from the terminal unit 1, the ID information of the relevant terminal unit 1, and model information.

The integration processing means 22 integrates the sound data and the operated-key data respectively received from the sound-data acquiring means 20 and the operated-key data acquiring means 21. In the integration process, the start key or the like depressed at a start of voice data input is taken as a reference for example, to carry out an integration process with a correspondence between the sound data and the operated-key data.

The music-data producing means 23 has melody-data producing means 23a for producing melody data and accompaniment-data producing means 23b for producing and adding accompaniment data such as chords.

The melody-data producing means 23a receives the melody voice information and operated-key data acquired by the sound-data acquiring apparatus 2a and operated-key data acquiring means 21, and produces a melody on the basis of these pieces of information. Specifically, the information outputted from the sound-data acquiring apparatus 2a is extracted for a time of from the timing the key is depressed to the timing the depression is released, to detect a basic frequency of the melody voice in the timing-to-timing duration and determine a pitch. Concurrently, a note value for the pitch is determined on the basis of the timing spacing.

The accompaniment-data producing means 23b produces a chord progression as accompaniment data depending upon the produced melody data. In the chord production, all the chord progressions allowed under the common chord progression are first listed up for the given melody data. This chord progression is governed by the rule groups called “prohibitive rules “under the law of harmonics, i.e. rule groups including preferably done so”, should be done so”, “should not be done so” and so on. For a common chord, the first inversion type and second inversion type are all taken into account. A dominant chord is produced, by taking account of 7's chord and 9's chord up to the inversion types thereof. For all the chords thus produced, the chord progressions are evaluated according to an evaluation table previously set. The chord group best evaluated is extracted and assigned to the melody.

The format changing means 24 is for converting the produced music data into a format to be outputted based on each model of terminal unit 1. The music data is converted depending upon the model information sent from the terminal unit 1. The format changing means 24 previously stores model information and the corresponding outputtable file format, in the not-shown storing means of the music producing server apparatus 2b so that the file format can be read out and converted into a form depending upon a model information of terminal unit 1.

The music data transmitting means 25 sends the music data thus format-changed to the terminal unit 1 corresponding to the terminal ID through the data communication line 3b, to thereby store it in the storing means 16 of the terminal unit 1. Because this is to send a file converted as digital information, the sending is toward the e-mail address contained within the ID information about terminal unit 1 via the data communication line 3b.

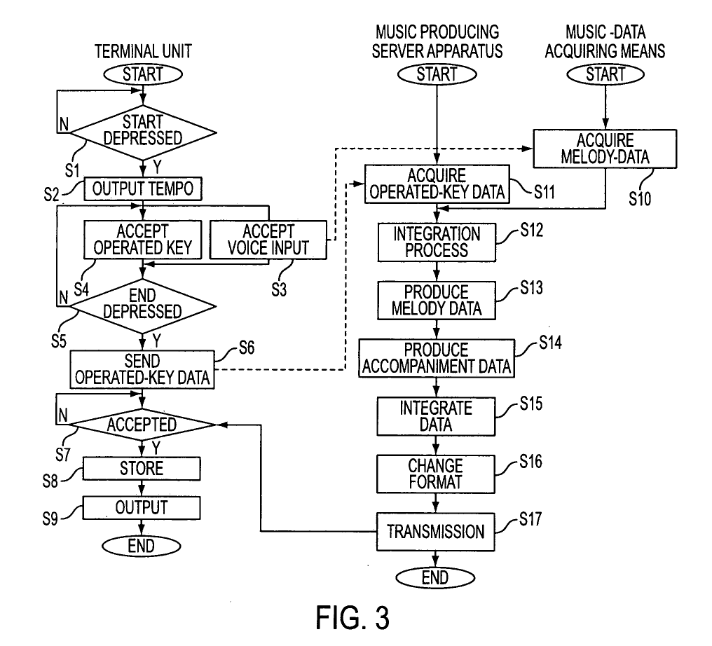

An exemplary method of using the music data producing system 4 (FIG. 2) to produce an incoming indicator melody is now explained with reference to FIG. 2, the flow diagram outlined in FIG. 3, and FIG. 4.

At first, in the case the user produces a self-composed melody, the application program for melody production is started up at the terminal unit 1 (FIG. 2). Following an operation guide as shown in FIG. 4, a depression of the start key is accepted for inputting a melody voice (S1), as shown in FIG. 3. By accepting a key corresponding to the start key on display over the display screen, a tempo is outputted (S2). The telephone line is connected to the sound-data acquiring apparatus 2a (FIG. 2), to thereby accept an input of melody voice (S3), as shown in FIG. 3. Concurrently, the key depression based on rhythm timing is allowed for acceptance (S4). Whenever the key is depressed, timing is detected to display voice length data for user's confirmation on the display screen of the terminal unit 1 (FIG. 4). As shown in FIG. 3, when melody voice input is completed, depressing an end key is accepted (S5) to send operated-key data together with a telephone number, e-mail address, etc. as ID information about the terminal unit 1 (FIG. 2) onto the music generating server apparatus 2b (FIG. 2), as shown at S6 in FIG. 3.

Referring now to S10 FIG. 3, in response, the sound-data acquiring apparatus 2a (FIG. 2) acquires as analog information the melody voice inputted at the terminal unit 1(FIG. 2), and recognizes the ID information about terminal unit 1 to thereby deliver these pieces of information to the music producing server apparatus 2b (FIG. 2).

Referring now to S11 (FIG. 3), the music producing server apparatus 2b (FIG. 2) acquires the operated-key data sent from the terminal unit 1 (FIG. 2), together with the ID information about terminal unit 1 (S11), and delivers the information to the integration processing means 22 (FIG. 2).

Based upon this, the music producing server apparatus 2b (FIG. 2) makes an integration process of the melody voice and operated-key data separately received, as shown in S12 (FIG. 3). The integration-processed data is delivered to the melody-data producing means 23a (FIG. 2). The melody-data producing means 23a recognizes a depression time point of the operated-key data, to cut of the voice data in a time period of from the timing of key depression to the timing of its release and of a time length up to the next depression time point, thereby detecting a basic frequency of the cut voice data and recognizing a pitch. Concurrently, on the basis of the timing-to-timing spacing, recognized is a note value from the sound having a pitch recognition-processed earlier, i.e. a length on music paper corresponding to a quarter note, an eighth note, etc. Depending upon these pieces of information, melody data is produced (S13, FIG. 3).

Referring again to FIG. 3, after producing melody data as in the above, all the chords corresponding to the melody are produced based upon the data according to the prohibitive rule (S14). From these, the chord progression evaluated best is extracted and assigned to the voices of the melody data (S15).

In order to output the produced music data at the end of terminal unit 1 (FIG. 2), the model information about terminal unit 1 is read out and converted in format into a form for output at the terminal unit 1 (S16). The converted file is sent, as an attachment file, to the e-mail address of terminal unit 1 (S17). By allowing the terminal unit 1 to receive the information (S7), the information is reproducibly stored in the storing means 16 (S8) so that it can be outputted as an incoming indicator melody or the like (S9).

In this manner, the above embodiment accepts an input of melody voice from the microphone and a key depression corresponding to a rhythm of the melody for input. Depending upon the accepted key depression timing, pitch information and note-value information are extracted from the melody voice, thereby producing music data. Accordingly, even where there is an input of a melody voice smoothly changing or continuing in pitch or even where there comes a rest, the voice can be determined correctly.

Meanwhile, when producing music data, melody data is produced based on the voice inputted by the user. Also, depending upon the melody data, accompaniment data such as chords, is produced for assignment, respectively. Accordingly, it is possible to provide a high level of chorded tune without limited to the mere same melody as a melody voice inputted by the user.

Furthermore, the configuration is made such that melody voice input, key depression and audio output are effected at the end of terminal unit 1 (FIG. 2) while music-data producing process is executed at the end of music generating server apparatus 2b (FIG. 2). By using a well-functioning computer at the end of music generating server apparatus 2b, accurate and uniform producing process of music data is made possible without relying upon the function of terminal unit 1. In addition, for the terminal units 1 already under marketing, it is possible to provide music data producing service based on melody voice without the necessity of downloading the software for producing music data.

Referring again to FIG. 2, when sending the music data produced by the music producing server apparatus 2b onto the terminal unit 1, the music data in sending is converted into a file form for output at the terminal unit 1. This eliminates the necessity of file conversion at the end of terminal unit 1. Particularly, where the terminal unit 1 is a small-sized terminal such as a cellular phone, it is possible to suppress the battery power consumption based on file conversion.

Incidentally, it should be appreciated that the present invention can be carried out in a variety of ways without limited to the foregoing embodiment.

For example, the foregoing embodiment carries out a producing process of melody or chord at the side of music producing server apparatus 2b. However, where these processes are possible on the terminal unit 1, the terminal unit 1 may be provided with those functions. In case all the functions concerning music data production are provided at the end of terminal unit 1, the music-data producing system 4 is the terminal unit 1.

Although the exemplary embodiment detects a pitch by detecting a frequency in a timing spacing between a key depression and a release therefrom, the invention is not limited to this, i.e. a pitch may be detected by detecting a frequency in a given time period at around a timing of key depression. Otherwise, a pitch may be detected by detecting a frequency in a duration of from a timing of key depression to a timing of the next key depression.

Although the exemplary embodiment sends a melody voice and operated-key data separately, a melody voice and operated-key data may be sent together to the music producing server apparatus 2b. With this configuration, there is no need for the music-producing server apparatus 2b to make a process of data comparison or the like. This can relieves the processing on the music-producing server apparatus 2b.

Although the embodiment exemplified the incoming indicator melody as a use example of to-be-produced music data, the invention is not limited to this, i.e. usable for the music for usual listening.

Although the exemplary embodiment not only converts an inputted melody voice into music data having the same melody but also provides chords, the processing may be only on the process of conversion merely into the same music data as an input melody voice. Meanwhile, it may be selectable whether to make a conversion only into melody data or to provide chords, depending upon a user's desire.

The present invention accepts an input of a melody voice the user is singing to himself/herself and a key depression corresponding to a rhythm of the melody voice to be inputted. Depending upon a timing of the accepted key depression, voice pitch information and note value information are extracted from the melody voice. Because music data can be produced based on these pieces of information, even where the melody voice to be inputted is something like smoothly changing or continuing in equal pitch or containing a rest, it can be correctly determined.

While exemplary embodiments of the invention have been described and illustrated, various changes and modifications may be made without departing from the spirit or scope of the invention. Accordingly, the invention is not limited by the foregoing description, but is only limited by the scope of the appended claims.

What is claimed as new and desired to be protected by Letters Patent of the United States is:

1. A music data producing system comprising:
sound accepting means for accepting an input of a melody voice;
key depression accepting means for accepting a depression of a key corresponding to a rhythm of the melody voice to be inputted;
music data producing means for producing music data depending upon a voice and rhythm timing accepted by the sound accepting means and key depression accepting means; and
output means for outputting the music data produced by the music data producing means.

2. The music data producing system according to claim 1, wherein said music data produced by said music data producing means comprises both melody data and accompaniment data.

3. The music data producing system according to claim 2, wherein the melody data produced depends upon a voice and rhythm timing accepted by the sound accepting means and key depression accepting means and wherein said accompaniment data produced depends upon said melody data.

4. The music data producing system according to claim 1, wherein at least the sound accepting means, the key depression accepting means and the output means are provided in a terminal unit.

5. The music data producing system according to claim 4, wherein the music data producing means is provided in a server apparatus.

6. The music data producing system according to claim 4, wherein the terminal unit is a cellular telephone.

7. A server apparatus provided for communications with a terminal unit saidserver apparatus comprising:
music data producing means for producing music data depending upon a voice and rhythm timing accepted by the sound accepting means and key depression accepting means; and
transmitting means for sending music data produced by the music data producing means to a terminal unit.

8. The server apparatus according to claim 7, wherein said music data produced by said music data producing means comprises both melody data and accompaniment data.

9. The music data producing system according to claim 8, wherein the melody data produced depends upon a voice and rhythm timing accepted by the sound accepting means and key depression accepting means and wherein said accompaniment data produced depends upon said melody data.

10. A server apparatus according to claim 7, wherein the transmitting means converts said music data into a format corresponding to the specifications of a terminal unit.

11. The server apparatus of claim 10, wherein said terminal apparatus is a cellular telephone.

12. A music data producing method comprising:
inputting a melody voice;
inputting a key depression timing corresponding to a rhythm of said melody voice;
outputting said melody voice and said key depression timing to a melody-data producing means;
integrating said melody voice and said key depression timing to produce musical data; and
outputting said musical data.

13. The method of claim 12, wherein said melody voice and said key depression timing is inputted from a terminal device.

14. The method of claim 13, wherein said terminal device is a cellular telephone.

15. The method of claim 12, wherein said melody voice is produced by a user.

16. The method of claim 12, wherein said step of integrating said melody voice and said key depression timing further comprises using said key depression timing to cut said melody voice into musical notes having a distinct pitch and note value.

17. The method of claim 13, further comprising the steps of:
inputting specifications from said terminal unit;
converting said musical data to match said specifications of said terminal unit; and
outputting said converted musical data to said terminal unit.

18. The method of claim 17, further comprising the steps of:
storing said converted musical data in said terminal unit; and
outputting said converted musical data as an incoming indicator melody.

19. A music data producing method comprising:
inputting a melody voice;
inputting a key depression timing corresponding to a rhythm of said melody voice;
outputting said melody voice and said key depression timing to a melody-data producing means;
integrating said melody voice and said key depression timing to produce melody data and accompaniment data; and
outputting said musical data.

20. The method of claim 19, wherein said step of integrating said melody voice and said key depression timing further comprises using said key depression timing to cut said melody voice into musical notes having a distinct pitch and note value.

21. The method of claim 19, wherein said accompaniment data is produced based on said melody data.

22. The method of claim 21, wherein said accompaniment data are chords corresponding to the melody.

23. The method of claim 19, wherein said melody voice and said key depression timing is inputted from a terminal device.

24. The method of claim 19, wherein said terminal device is a cellular telephone.
